(19) United States
(12) Patent Application Publication
(10) Pub. No.: US 2010/0091145 A1
(43) Pub. Date: Apr. 15, 2010

(54) FIXED-PATTERN NOISE REDUCTION SYSTEM, IMAGING SYSTEM, AND ELECTRONIC ENDOSCOPE UNIT

(75) Inventor: Hiroki ISERI, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/576,428

(22) Filed: Oct. 9, 2009

(30) Foreign Application Priority Data
Oct. 14, 2008 (JP) 2008-265442

(51) Int. Cl. H04N 9/64

(52) U.S. Cl. 348/243; 348/E09.037

(57) ABSTRACT

A fixed-pattern noise reduction system comprising a receiver, a determination circuit, an image sensor driver, a subtracter and an output circuit is provided. The receiver receives optical pixel signals and artificial black pixel signals. The determination circuit determines whether the signal intensity of the optical pixel signal is less than a threshold. The image sensor driver orders the image sensor to carry out a second capture at least one time after the signal intensity of the optical pixel signal is less than the threshold. The subtracter subtracts noise signals from the optical pixel signals. The noise signals are generated on the basis of the artificial black pixel signal. The output circuit outputs the optical pixel signals that the subtracter subtracts the noise signals from after carrying out the second capture after carrying out the second capture.

### BACKGROUND OF THE INVENTION

1. Field of the Invention

The present invention relates to a fixed-pattern noise reduction system that reduces the effect of fixed-pattern noise that varies in respective pixels, such as of a CMOS image sensor.

2. Description of the Related Art

A CMOS image sensor that enables low power consumption and low manufacturing cost is known. In a CMOS image sensor, an amplifier is mounted in each of the pixels. Accordingly, fixed-pattern noise, which varies in respective pixels, appears in the pixels.

Japanese Unexamined Patent Publication No. H10-313428 proposes that fixed-pattern noise is removed from image data using artificial fixed-pattern noise generated from an electric shutter function with a short exposure time setting.

However, if an exposure time cannot be set short enough or too great an amount of light is incident on an image sensor, the accuracy of artificial fixed-pattern noise will be mitigated. Accordingly, in such situations fixed-pattern noise cannot be accurately removed from image data.

### SUMMARY OF THE INVENTION

Therefore, an object of the present invention is to provide a fixed-pattern noise reduction system that has a brief structure and effectively removes fixed-pattern noise.

According to the present invention, a fixed-pattern noise reduction system comprising a receiver, a determination circuit, an image sensor driver, a subtracter and an output circuit is provided. The receiver receives optical pixel signals and artificial black pixel signals. Pixels generate the optical pixel signals according to the amounts of light received for the duration of a photographing exposure time. The pixels are arranged on an image sensor. The pixels generate the artificial black pixel signals according to the amounts of light received for the duration of a instantaneous exposure time shorter than the photographing exposure time. The determination circuit determines whether or not the signal intensity of the optical pixel signal is less than a threshold. The image sensor driver orders the image sensor to repeat a first capture until the determination circuit determines that the signal intensity of the optical pixel signal is less than the threshold. The image sensor driver orders the image sensor to carry out a second capture at least one time and to repeat the first capture after the determination circuit determines that the signal intensity of the optical pixel signal is less than the threshold. The pixels of the image sensor generate optical pixel signals for one frame of an image signal for the duration of the photographing exposure time in the first capture. The pixels of the image sensor generating artificial black pixel signals for one frame of an image signal for the duration of the instantaneous exposure time in the second capture. The subtracter subtracts noise signals from the optical pixel signals. The noise signals are generated on the basis of the artificial black pixel signal. The output circuit outputs the optical pixel signals before carrying out the second capture. The output circuit outputs the optical pixel signals that the subtracter subtracts the noise signals from after carrying out the second capture.

According to the present invention, an imaging system comprising an image sensor, a determination circuit, an image sensor driver, a subtracter and an output circuit is provided. Pixels are arranged on the image sensor. The pixels generate the optical pixel signals according to the amounts of light received for the duration of a photographing exposure time. The pixels generate the artificial black pixel signals according to the amounts of light received for the duration of a instantaneous exposure time shorter than the photographing exposure time. The determination circuit determines whether or not a signal intensity of the optical pixel signal is less than a threshold. The image sensor driver orders the image sensor to repeat a first capture until the determination circuit determines that the signal intensity of the optical pixel signal is less than the threshold. The image sensor driver orders the image sensor to carry out a second capture at least one time and to repeat the first capture after the determination circuit determines that the signal intensity of the optical pixel signal is less than the threshold. The pixels of the image sensor generate optical pixel signals for one frame of an image signal for the duration of the photographing exposure time in the first capture. The pixels of the image sensor generate artificial black pixel signals for one frame of an image signal for the duration of the instantaneous exposure time in the second capture. The subtracter subtracts noise signals from the optical pixel signals. The noise signals are generated on the basis of the artificial black pixel signal. The output circuit outputs the optical pixel signals before carrying out the second capture. The output circuit outputs the optical pixel signals that the subtracter subtracts the noise signal from after carrying out the second capture.

According to the present invention, an electronic endoscope unit comprising an image sensor, a determination circuit, an image sensor driver, a subtracter and an output circuit is provided. Pixels are arranged on the image sensor. The pixels generate the optical pixel signals according to the amounts of light received for the duration of a photographing exposure time. The pixels generate the artificial black pixel signals according to the amounts of light received for the duration of a instantaneous exposure time shorter than the photographing exposure time. The determination circuit determines whether or not the signal intensity of the optical pixel signal is less than a threshold. The image sensor driver orders the image sensor to repeat a first capture until the determination circuit determines that the signal intensity of the optical pixel signal is less than the threshold. The image sensor driver orders the image sensor to carry out a second capture at least one time and to repeat the first capture after the determination circuit determines that the signal intensity of the optical pixel signal is less than the threshold. The pixels of the image sensor generate optical pixel signals for one frame of an image signal for the duration of the photographing exposure time in the first capture. The pixels of the image sensor generate artificial black pixel signals for one frame of an image signal for the duration of the instantaneous exposure time in the second capture. The subtracter subtracts noise signals from the optical pixel signals. The noise signals are generated on the basis of the artificial black pixel signal. The output circuit outputs the optical pixel signals before carrying out the second capture. The output circuit outputs the optical pixel signals that the subtracter subtracts the noise signal from after carrying out the second capture.

### BRIEF DESCRIPTION OF THE DRAWINGS

The subjects and advantages of the present invention will be better understood from the following description, with reference to the accompanying drawings in which:

FIG. 1 is a block diagram showing the internal structure of an endoscope unit having the fixed-pattern noise reduction system of the first embodiment of the present invention;

FIG. 2 is a block diagram showing the internal structure of an image processing block of the first embodiment;

FIG. 3 is a flowchart illustrating the process of the generation of noise data and the FPN removal in the first embodiment;

FIG. 4 is a block diagram showing the internal structure of an image processing block of the second embodiment;

FIG. 5 is a flowchart illustrating the process of the generation of noise data and the FPN removal in the second embodiment;

FIG. 6 is a block diagram showing the internal structure of an image processing block of the third embodiment; and

FIG. 7 is a flowchart illustrating the process of the generation of noise data and the FPN removal in the second noise data generating mode in the third embodiment.

### DESCRIPTION OF THE PREFERRED EMBODIMENTS

The present invention is described below with reference to the embodiments shown in the drawings.

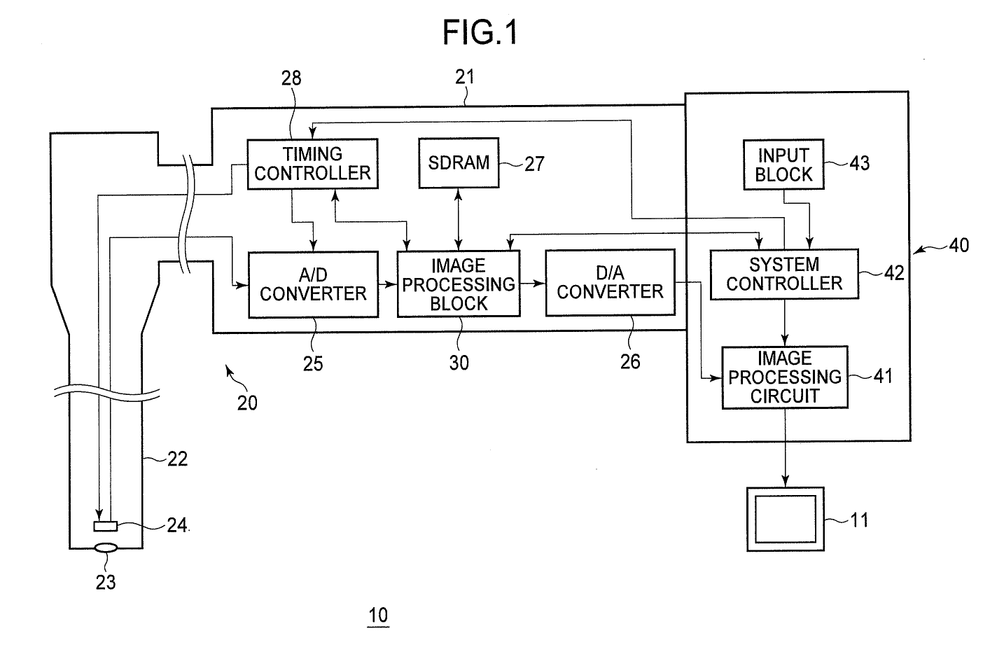

In FIG. 1, an electronic endoscope unit 10 comprises an electronic endoscope 20, an endoscope processor 40, and a monitor 11. The endoscope processor 40 is connected to the electronic endoscope 20 and the monitor 11.

The endoscope processor 40 comprises a light-source unit (not depicted). Illumination light emitted from the light-source unit is transmitted to the head end of an insertion tube 22 by a light guide mounted from the connector 21 to the head end of the insertion tube 22.

The illumination light transmitted by the light guide illuminates a peripheral area near the head end of the insertion tube 22. An optical image of light reflected from the subject illuminated by the illumination light is captured by the electronic endoscope 20. The electronic endoscope 20 generates an image signal corresponding to the captured optical image. The image signal is transmitted to the endoscope processor 40.

The endoscope processor 40 comprises an image processing circuit 41. The image processing circuit 41 carries out predetermined signal processing on the image signal received from the electronic endoscope 20. The image signal, having undergone predetermined signal processing, is transmitted to the monitor 11, where an image corresponding to the received image signal is displayed.

The operations of the light-source unit and the image processing circuit 41 are controlled by a system controller 42 that is a component of the endoscope processor 40. In addition, the system controller 42 is connected to the electronic endoscope 20, and controls the operations of the components of the electronic endoscope 20.

In addition, the endoscope processor 40 comprises an input block 43. When a user inputs a command to the input block 43, an order signal according to the input command is transmitted from the input block 43 to the system controller 42. The system controller 42 controls the operations of the components on the basis of the received order signal.

The electronic endoscope 20 comprises an object lens 23, an image sensor 24, an A/D converter 25 (receiver), an image processing block 30, a D/A converter 26, an SDRAM 27, a timing controller 28 (image sensor driver), and other components.

As described above, an optical image of a subject illuminated by the illumination light reaches a light-receiving surface of the image sensor 24 through the object lens 23. The timing controller 28 drives the image sensor 24 to generate an image signal corresponding to the optical image that reaches the light-receiving surface.

The image sensor 24 is a CMOS image sensor. A plurality of pixels (not depicted) is arranged in a matrix on the light-receiving surface. Each pixel generates a pixel signal according to an amount of received light.

A pixel signal comprises a fixed pattern noise (FPN) component and a light component in proportion to an amount of received light. The FPN component is noise that is unique to each pixel and that is constant and unrelated to an exposure time. On the other hand, the light component varies according to an integrated exposure amount. In other words, the light component varies according to the product of the amount of incident light and an exposure time.

The timing controller 24 controls the timing of the output of every pixel signal which is generated by each respective pixel and output in order from the image sensor 24. One frame of an image signal comprises the pixel signals generated by all the pixels arranged on the light-receiving surface.

As described later, the timing controller 28 can adjust the exposure time to the pixels. In addition, the timing controller 28 controls the time of some operations of the A/D converter 25 and the image processing block 30.

The generated image signal is transmitted from the image sensor 24 to the A/D converter 25. The A/D converter 24 digitizes the received image signal, and converts the image signal into image data. The image data comprises pixel data digitized from the pixel signals.

The image data are transmitted to the image processing block 30. The image processing block 30 carries out predetermined image processing, which includes FPN removal processing, on the received image data. The image processing block 30 is connected to the SDRAM 27. The SDRAM 27 stores image data used for the FPN removal.

The image data, having undergone predetermined image processing, is transmitted to the D/A converter 26. The D/A converter 26 converts the received image data into an analog image signal. The image signal is transmitted to the image processing circuit 41 in the endoscope processor 40. As described above, the image processing circuit 41 carries out predetermined signal processing on the received image signal, and the image signal is transmitted to the monitor 11 where an image is displayed.

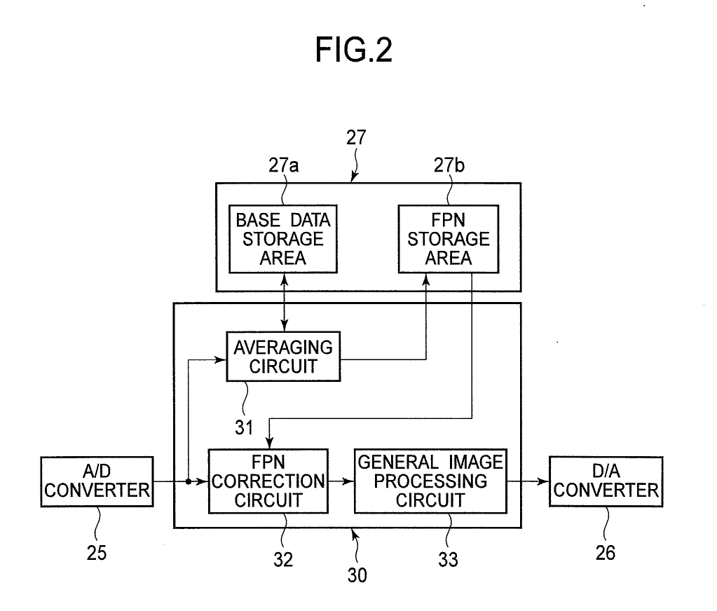

Next, the FPN removal carried out by the image processing block 30 is explained with the structure of the image processing block 30. As shown in FIG. 2, the image processing block 30 comprises an averaging circuit 31, an FPN correction circuit 32 (subtracter), a general image processing circuit 33, and other components.

In order to remove the FPN component from a pixel signal, a noise signal that is equivalent to an FPN component that is unique to each of the pixels is necessary. Before the FPN removal, noise data corresponding to the noise signal is generated by the image processing block 30.

As described above, pixel data comprise the FPN component and the light component. Accordingly, the noise data that can be regarded as the FPN component can be generated by generating pixel data so that the light component is zero. For the generation of the noise data, the pixel data should be generated under the conditions of very short exposure time and adequate brightness (not over brightness).

To determine whether or not the amount of incident light on the image sensor 24 is too great, the timing controller 28 orders the image sensor 24 to capture an optical image in a photographing exposure time, which is an exposure time for capturing an optical image, such as 1/60 second, and to generate successive frames of an optical image signal, which is an image signal generated within the photographing exposure time upon starting the electronic endoscope 20.

If the exposure time is 1/60 second, the generated pixel signal is transmitted as the optical pixel data to the FPN correction circuit 32. As described later, the FPN correction circuit 32 removes the FPN component from the optical pixel data using the noise data read out from the SDRAM 27. Before generating the noise data, the FPN correction circuit 32 transmits the received optical pixel data to the general image processing circuit 33 without the FPN removed.

The general image processing circuit 33 carries out predetermined image processing, such as color interpolation processing, and gamma correction processing, on the received pixel data. As described above, the pixel data, having undergone predetermined image processing, is transmitted to the D/A converter 26. Accordingly, an image without the FPN removed is displayed on the monitor 11 before generating the noise data.

Before carrying out predetermined image processing, the general image processing circuit 33 detects the maximum value of the luminance components in the pixel data that the optical image data comprises on the basis of the optical image data. In addition, the general image processing circuit 33 determines whether or not the maximum value is less than a threshold, of which the data value is predetermine to be x (x>1).

If the maximum value of the luminance components is greater than or equal to the threshold, capture of the optical image with the photographing exposure time of 1/60 second is repeated. If the maximum value of the luminance components is less than the threshold, the general image processing circuit 33 orders the timing controller 28 and the image processing block 30 to carry out operations for generating noise data.

When the timing controller 28 is ordered to start generating the noise data, the timing controller 28 orders the image sensor 24 to capture an optical image by exposing the optical image to the image sensor during the photographing exposure time divided by the threshold (i.e. 1/60x second), and the image sensor 24 generates a frame of a blocked image signal.

If the exposure time is 1/60×, the generated pixel signals are transmitted to the averaging circuit 31 as artificial black pixel data. The averaging circuit 31 is connected to the SDRAM 27. The SDRAM 27 has a base data storage area 27a and an FPN storage area 27b.

The averaging circuit 31 stores the received artificial black pixel data in the base data storage area 27a. The base data storage area 27a has a capacity to store eight frames of blocked image data. The artificial black pixel data are stored in a location, which is determined according to the order of the frame and the location of the pixels, in the base data storage area 27.

When the artificial black pixel data, which constitutes one frame of image data, is stored in the base data storage area 27a, the timing controller 28 orders the image sensor 24 again to repeatedly capture an optical image with the photographing exposure time of 1/60 second.

Afterward, the determination of whether the maximum value of the luminance components is less than the threshold, the capture with the exposure time of 1/60x second, and the storage of the artificial black pixel data are repeated until eight frames of blocked image data are stored in the base data storage area 27a.

When eight frames of the blocked image data are stored in the base data storage area 27a, the averaging circuit 31 reads out eight artificial black pixel data that correspond to the same pixels and are included in a different frame of blocked image data. The averaging circuit 31 averages the values of eight artificial black pixel data, and generates the noise data for each pixel. The noise data are generated for all of the pixels and stored in the FPN storage area 27b.

When the noise data are generated, the timing controller 28 orders the image sensor 24 to generate the optical image signal with the photographing exposure time of 1/60 second. Then pixel signals that constitutes one frame of the optical image signal are transmitted as optical pixel signals, in order, to the image processing block 30 via the A/D converter 25.

As described above, if the exposure time is 1/60 second, the generated and digitized optical pixel data are transmitted to the FPN correction circuit 32. The FPN correction circuit 32 reads out the noise data of the pixel corresponding to the received optical pixel data from the SDRAM 27. The FPN correction circuit 32 removes the FPN components by subtracting the noise data from the optical pixel data.

As described above, the optical pixel data that have had the FPN component removed are transmitted to the general image processing circuit 33, which carries out predetermined image processing, such as color interpolation processing and gamma correction processing. The optical image data, having undergone predetermined image processing, are transmitted to the D/A converter 26, as described above.

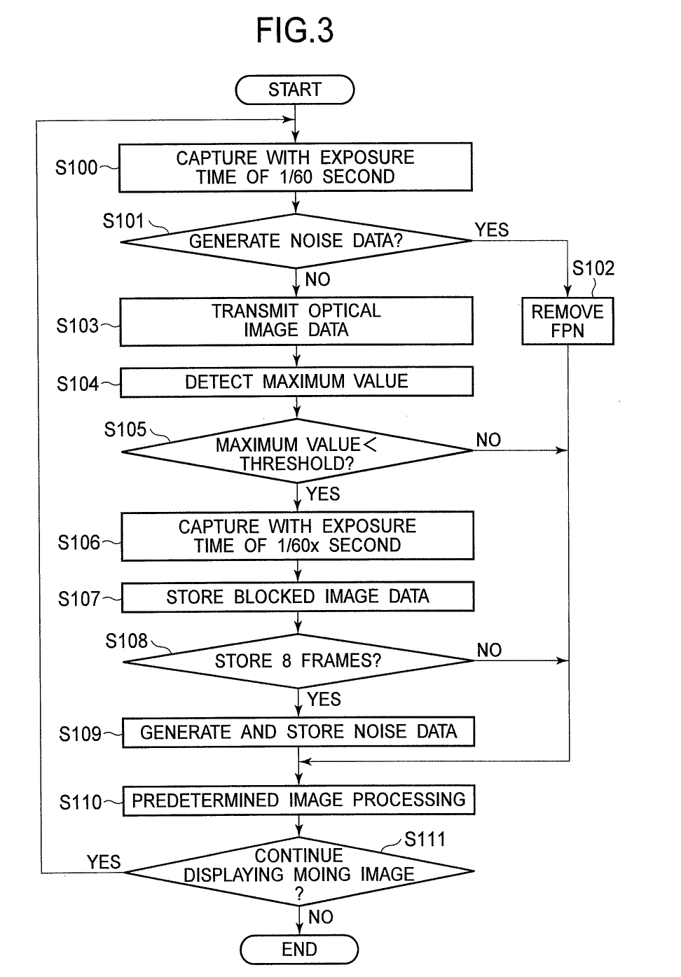

Next, the process of generating the noise data and removing the FPN, which is carried out by the timing controller 28 and the image processing block 30, is explained using the flowchart of FIG. 3. The process of generating the noise data and removing the FPN commences when the electronic endoscope unit 10 is switched on.

At step S100, the timing controller 28 orders the image sensor 24 to capture an optical image in the exposure time of 1/60 second to generate one frame of an optical image signal. After generation of the optical image signal, the process proceeds to step S101.

At step S101, the image processing block 30 determines whether or not the noise data was generated and stored. When the noise data was generated, the process proceeds to step S102. On the other hand, when the noise data was not generated, the process proceeds to step S103.

At step S102, the image processing block 30 removes the FPN component from the optical image signal, which was generated at step S10 and digitized, by subtracting the noise data stored in the SDRAM 27 from the optical image data. After removing the FPN components, the process proceeds to step S110.

At step S103, the image processing block 30 transmits the optical image signal, which was generated at step S100 and digitized, to the general image processing circuit 33. After transmission, the process proceeds to step S104.

At step S104, the general image processing circuit 33 of the image processing block 30 detects the maximum value of the luminance component among the optical pixel data constituting the optical image data that was generated at step S100. After detecting the maximum value, the process proceeds to step S105.

At step S105, the general image processing circuit 33 determines whether or not the maximum value is less than the threshold. When the maximum value is less than the threshold, the process proceeds to step S106. On the other hand when the maximum value is not less than the threshold, the process proceeds to step S110.

At step S106, the timing controller 28 orders the image sensor 24 to capture an optical image during the exposure time of 1/60x second for generating one frame of a blocked image signal. After the generation of the blocked image signal, the process proceeds to step S107.

At step S107, the image processing block 30 stores the blocked image data, which was generated at step S106 and digitized, in the SDRAM 27. After storing the blocked image data, the process proceeds to step S108.

At step S108, the image processing block 30 determines whether or not eight frames of blocked image data are stored in the SDRAM 27. When eight frames of blocked image data are stored, the process proceeds to step S109. On the other hand, when less than eight frames of blocked image data are stored, the process proceeds to step S110.

At step S109, the image processing block 30 averages the values of the eight artificial black pixel data corresponding to the same pixels, and generates the noise data for each pixel. In addition, the image processing block 30 stores the generated noise data in the SDRAM 27. After storing the noise data, the process proceeds to step S110.

At step S110, the image processing block 30 carries out predetermined image processing, such as color interpolation processing and gamma correction processing, on the image data. After carrying out predetermined image processing, the process proceeds to step S111.

At step S111, the image processing block 30 determines whether or not a command to terminate the display of moving images has been input to the input block 43. When the command to terminate has not been input, the process returns to step S100. From that point, steps S100-S111 are repeated until the command to terminate is input. When the command to terminate is input, the process of generating the noise data and removing the FPN is terminated.

In the above first embodiment, fixed-pattern noise can be accurately removed with a brief structure of the system because the noise data are generated by shortening the exposure time when there is not a large amount of incident light.

Next, a fixed-pattern noise reduction system of the second embodiment is explained. The primary difference between the second embodiment and the first embodiment is the method of generating the noise data. The second embodiment is explained mainly with reference to the structures that differ from those of the first embodiment. Here, the same index numbers are used for the structures that correspond to those of the first embodiment.

The structures and the functions of the components of the electronic endoscope in the second embodiment are the same as those of the first embodiment, except for the image processing block. In addition, the endoscope processor and the monitor in the second embodiment are the same as in the first embodiment.

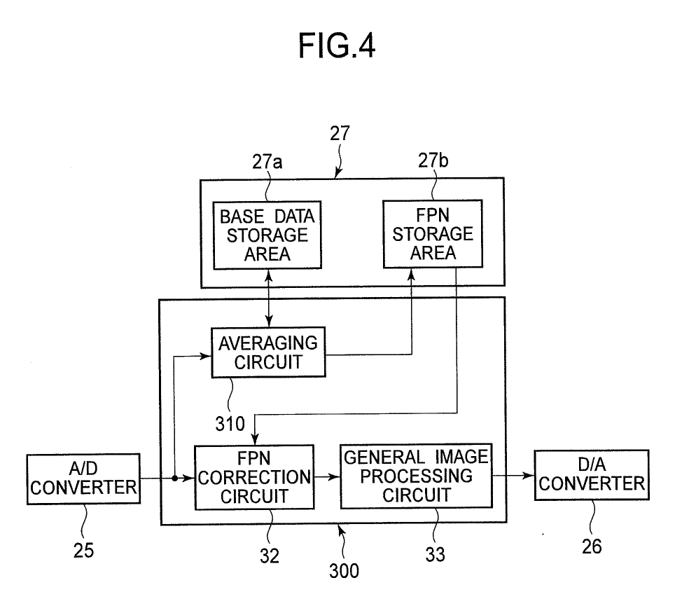

The FPN removal carried out by the image processing block in the second embodiment is explained in addition to the structure and the function of the image processing block. As shown in FIG. 4, the image processing block 300 comprises an averaging circuit 310, an FPN correction circuit 32, a general image processing circuit 33, and other components.

The timing controller 28 orders the image sensor 24 to capture an optical image in the photographing exposure time for photographing, such as 1/60 second, and to generate successive frames of an optical image signal upon starting the electronic endoscope 20, as in the first embodiment.

The determination of whether the maximum value of the luminance components among the pixel data, based on the exposure time of 1/60 second, is less than the threshold; the capture in the exposure time of 1/60x second; and the storage of the artificial black pixel data are all repeated until eight frames of blocked image data have been stored in the base data storage area 27a, as in the first embodiment.

Unlike in the first embodiment, the generation of the noise data commences before eight frames of blocked image data are stored in the base data storage area 27a, as explained below.

When one frame of the blocked image data is stored in the base data storage area 27a, the one stored frame of the blocked image data is read out by the averaging circuit 310. And then, the averaging circuit 310 stores the frame of the blocked image data as the noise data in the FPN storage area 27b.

When two or three frames of the blocked image data are stored in the base data storage area 27a, two frames of blocked image data from among all of the frames of the stored blocked image data are read out by the averaging circuit 310. And then, the averaging circuit 310 averages the blocked image data read out from the two frames. The noise data that had been stored in the FPN storage area 27b is replaced with new noise data that is the averaged blocked image data.

When four to seven frames of the blocked image data are stored in the base data storage area 27a, four frames of the blocked image data from among all of the frames of the stored blocked image data are read out by the averaging circuit 310. And then, the averaging circuit 310 averages the blocked image data read out from the four frames. The noise data that had been stored in the FPN storage area 27b is replaced with new noise data that is the averaged blocked image data.

When eight frames of the blocked image data are stored in the base data storage area 27a, all eight frames of the stored blocked image data are read out by the averaging circuit 310. And then, the averaging circuit 310 averages the blocked image data read out from the eight frames. The noise data that had been stored in the FPN storage area 27b is replaced with new noise data that is the averaged blocked image data. After generation of the noise data on the basis of eight frames of the blocked image data, the generation and the replacement of new noise data are suspended.

The optical image data that the optical image signal generated with the exposure time of 1/60 second are digitized and transmitted to the FPN correction circuit 32, as in the first embodiment. The FPN correction circuit 32 removes the FPN component from the optical image data using the noise data stored in the FPN storage area 27b.

Unlike in the first embodiment, the FPN component can be removed before eight frames of the blocked image data have been stored, as long as at least one frame of the blocked image data is stored.

The optical pixel data from which the FPN component is removed is transmitted to the general image processing circuit 33, which carries out predetermined image processing, as in the first embodiment. The pixel data, having undergone predetermined image processing, is transmitted to the D/A converter 26.

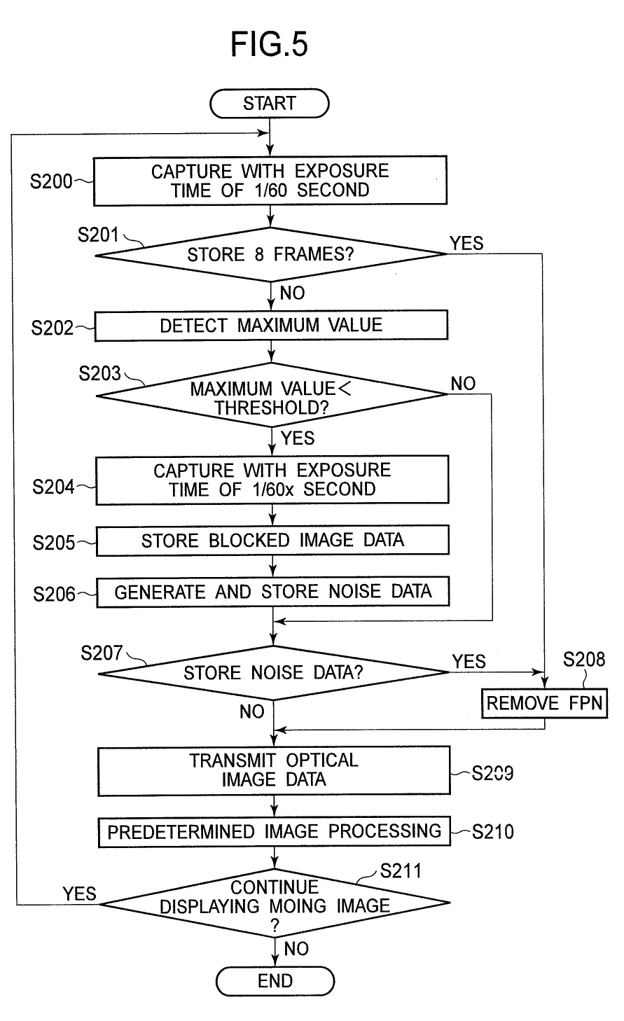

Next, the process of generating noise data and removing the FPN, which is carried out by the timing controller 28 and the image processing block 300, is explained using the flowchart of FIG. 5. The process of generating noise data and removing the FPN commences when the electronic endoscope unit 10 is switched on.

At step S200, the timing controller 28 orders the image sensor 24 to capture an optical image during the exposure time of 1/60 second for generating one frame of an optical image signal. After generation of the optical image signal, the process proceeds to step S201.

At step S201, the image processing block 300 determines whether or not eight frames of the blocked image data are stored in the SDRAM 27. When eight frames of the blocked image data are stored, the process skips steps S202-S207 and proceeds to step S208. On the other hand, when eight frames of the blocked image data are not stored, the process proceeds to step S202.

At step S202, the general image processing circuit 33 of the image processing block 300 detects the maximum luminance component value from among the optical pixel data in the optical image data generated in step S200. After detecting the maximum value, the process proceeds to step S203.

At step S203, the general image processing circuit 33 determines whether or not the maximum value is less than the threshold. When the maximum value is not less than the threshold, the process skips steps S204-S206 and proceeds to step S207. On the other hand, when the maximum value is less than the threshold, the process proceeds to step S204.

At step S204, the timing controller 28 orders the image sensor 24 to capture an optical image during the exposure time of 1/60x second for generating one frame of a blocked image signal. After generating the blocked image signal, the process proceeds to step S205.

At step S205, the image processing block 300 stores the blocked image data that was generated in step S204 and digitized in the SDRAM 27. After storing the blocked image data, the process proceeds to step S206.

At step S206, the image processing block 300 averages the values of artificial black pixel data, which are stored in the SDRAM 27 and correspond to the same pixels, and generates the noise data for each pixel. In addition, the image processing block 300 stores the generated noise data in the SDRAM 27. After storing the noise data, the process proceeds to step S207.

At step S207, the image processing block 300 determines whether or not the noise data are stored in the SDRAM 27. When the noise data are stored in the SDRAM 27, the process proceeds to step S208. On the other hand, when the noise data are not stored in the SDRAM 27, the process skips step S208 and proceeds to step S209.

At step S208, the image processing block 300 removes the FPN component from the optical image data, which was generated in step S200 and digitized, by subtracting the noise data stored in the SDRAM 27 from the optical image data. After removing the FPN components, the process proceeds to step S209.

At step S209, the general image processing circuit 33 receives the optical image data. At the following step S210, the image processing block 300 carries out predetermined image processing, such as color-interpolation processing and gamma-correction processing, on the image data. After carrying out predetermined image processing, the process proceeds to step S211.

At step S211, the image processing block 300 determines whether or not a command to terminate the display of moving images has been input to the input block 43. When the command for termination is not input, the process returns to step S200 and steps S200-S211 are repeated until the command for termination is input. When the command for termination is input, the process of generating noise data and removing the FPN terminates.

In the above second embodiment, fixed-pattern noise can be accurately removed with a brief structure of a system because the noise data are generated by reducing the exposure time when there is not a large amount of incident light.

In addition, in the second embodiment, even before eight frames of the blocked image data are generated, the noise data can be generated as long as at least one frame of the blocked image signal has been generated. The accuracy of the noise data increases in proportion to the number of frames of blocked image data. Accordingly, a sufficient amount of fixed-pattern noise cannot be accurately removed when only a small number of frames of blocked image data are used for generating the noise data. However, the removal of the FPN can begin early because the noise data are generated early.

Next, a fixed-pattern noise reduction system of the third embodiment is explained. The primary difference between the third embodiment and the first embodiment is that the method of generating the noise data can be changed. The third embodiment is explained mainly with reference to the structures that differ from those of the first embodiment. Here, the same index numbers are used for the structures that correspond to those of the first embodiment.

The structures and functions of the components of the electronic endoscope in the third embodiment are the same as those of the first embodiment, except for the image processing block. In addition, the endoscope processor and the monitor in the third embodiment are the same as those in the first embodiment.

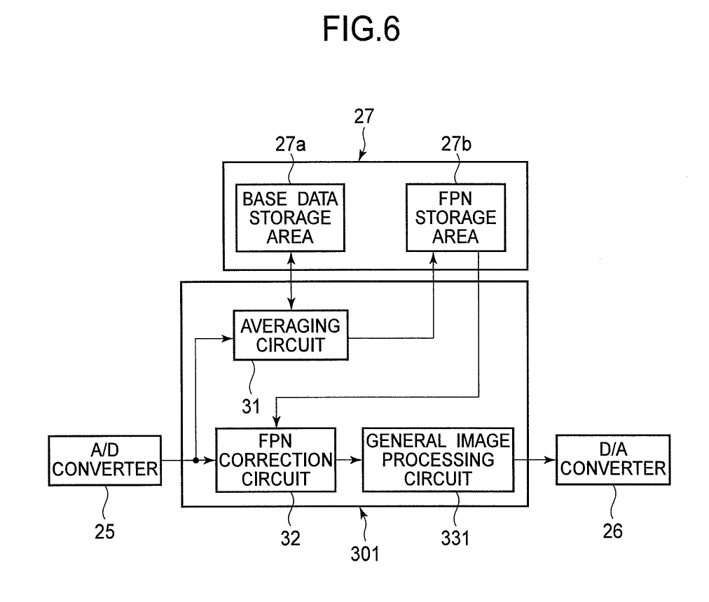

The FPN removal process carried out by the image processing block in the third embodiment is explained in addition to the structure and function of the image processing block. As shown in FIG. 6, the image processing block 301 comprises an averaging circuit 310, an FPN correction circuit 32, a general image processing circuit 331, and other components.

Unlike in the first embodiment, in the third embodiment the electronic endoscope 20 has first and second noise data generating modes. On the basis of a user's command input to the input block 24, either the first or second noise data generating modes is selected. In the first noise data generating mode, the noise data are generated according to the same method as that in the first embodiment.

In the second noise data generating mode, the timing controller 28 orders the image sensor 24 to capture an optical image in half of the photographing exposure time for photographing, such as 1/120 second, and to generate successive frames of an optical image signal upon starting the operation of the electronic endoscope 20.

If the exposure time is 1/120 second, the generated pixel signals are transmitted as optical pixel data to the FPN correction circuit 32. As described later, the FPN correction circuit 32 removes the FPN component from the optical pixel data using the noise data read out from the SDRAM 27. Before generating the noise data, the FPN correction circuit 32 transmits the received optical pixel data to the general image processing circuit 331 without removing the FPN.

The general image processing circuit 331 carries out predetermined image processing, such as color interpolation processing and gamma correction processing, on the received pixel data. As described above, the pixel data, having undergone predetermined image processing, is transmitted to the D/A converter 26. Accordingly, an image without having the FPN removed is displayed on the monitor 11 before generating the noise data.

Unlike in the first embodiment, if the exposure time is 1/120 second, the general image processing circuit 331 not only carries out predetermined image processing but also amplifies the pixel data by the gain of two. Accordingly, even if the exposure time of 1/120 second is half of the exposure time of 1/60 second, the brightness of the entire image displayed on the monitor 11 is nearly the same because the pixel data are amplified by two.

Before carrying out predetermined image processing, the general image processing circuit 331 detects the maximum luminance component value from among the optical pixel data in the optical image data generated in the exposure time of 1/120 second on the basis of the optical image data prior to carrying out predetermined image processing, as in the first embodiment. In addition, the general image processing circuit 331 determines whether or not the detected maximum value is less than a threshold, of which its data value is predetermined to be x (x>1), as in the first embodiment.

If the maximum value of the luminance components is more than or equal to the threshold, the captures of the optical image with the exposure time of 1/120 second are repeated, as in the first embodiment. If the maximum value of the luminance components is less than the threshold, the general image processing circuit 331 orders the timing controller 28 and the image processing block 301 to carry out operations for generating noise data.

When the timing controller 28 is ordered to start generating the noise data, the timing controller 28 orders the image sensor 24 to capture an optical image by exposing the optical image to the image sensor during half of the photographing exposure time divided by the threshold (i.e. 1/120x second), and the image sensor 24 generates a frame of a blocked image signal, as in the first embodiment.

If the exposure time is 1/120x, the generated pixel signals are transmitted to the averaging circuit 31 as artificial black pixel data, as in the first embodiment. The averaging circuit 31 stores the received artificial black pixel data in the base data storage area 27a.

When the artificial black pixel data, which constitutes one frame of image data, is stored in the base data storage area 27a, the timing controller 28 orders the image sensor 24 to repeatedly capture an optical image with the photographing exposure time of 1/120 second, as in the first embodiment.

Since then, the determination of whether the maximum value of luminance components is less than the threshold, the capture with the exposure time of 1/120x second, and the storage of the artificial black pixel data are all repeated until eight frames of blocked image data have been stored in the base data storage area 27a, as in the first embodiment.

When eight frames of the blocked image data generated in the exposure time of 1/120x second are stored in the base data storage area 27a, the averaging circuit 310 reads out eight artificial black pixel data that correspond to the same pixel and are included in the different frames of the blocked image data. The averaging circuit 310 averages the values of the eight artificial black pixel data and generates the noise data for each pixel.

Unlike in the first embodiment, after generating the noise data is completed the timing controller 28 orders the image sensor 24 to capture an optical image with the photographing exposure time of 1/60 second and to generate an optical image signal. The pixel signals that constitute one frame of the optical image signal are transmitted, in order, as optical pixel data to the image processing block 301 via the A/D converter 25.

If the exposure time is 1/60 second, the generated and digitized optical pixel data are transmitted to the FPN correction circuit 32. The FPN correction circuit 32 reads out the noise data of the pixel corresponding to the received optical pixel data from the SDRAM 27. The FPN correction circuit 32 removes the FPN components by subtracting the noise data from the optical pixel data.

The optical pixel data that the FPN component is removed from is transmitted to the general image processing circuit 331, which carries out predetermined image processing, such as color interpolation processing and gamma correction processing. If the exposure time is 1/60 second, the general image processing circuit 331 does not amplify the optical image data. The optical pixel data, having undergone predetermined image processing, are transmitted to the D/A converter 26, as described above.

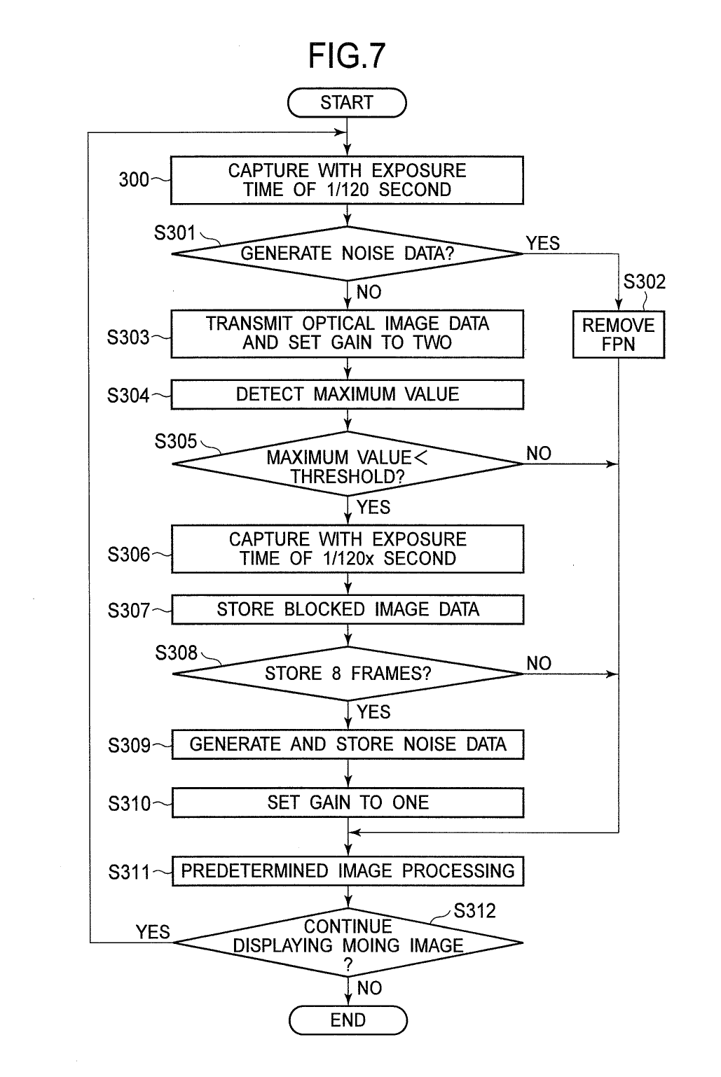

Next, the process for generating the noise data and removing the FPN, which is carried out by the timing controller 28 and the image processing block 301 in the second noise data generating mode, is explained using the flowchart of FIG. 7. The process of generating the noise data and removing the FPN commences when the electronic endoscope unit 10 is switched ON with the second noise data generating mode being selected.

At step S300, the timing controller 28 orders the image sensor 24 to capture an optical image during the exposure time of 1/120 second for generating one frame of optical image signal. After generating the optical image signal, the process proceeds to step S301.

At step S301, the image processing block 301 determines whether or not the noise data has been generated and stored. When the noise data has been generated, the process proceeds to step S302. On the other hand, when the noise data has not been generated, the process proceeds to step S303.

At step S302, the image processing block 301 removes the FPN component from the optical image data that was generated in step S300 and digitized, by subtracting the noise data stored in the SDRAM 27 from the optical image data. After removing the FPN components, the process proceeds to step S311.

At step S303, the image processing block 301 transmits the optical image signal, which was generated in step S300 and digitized, to the general image processing circuit 331. In addition, the image processing block 301 sets the gain used for the general image processing circuit 331 to amplify the image data to two. After setting the gain, the process proceeds to step S304.

At step S304, the general image processing circuit 331 of the image processing block 301 detects the maximum luminance component value from among the optical pixel data that constitute the optical image data generated in step S300. After detecting the maximum value, the process proceeds to step S305.

At step S305, the general image processing circuit 331 determines whether or not the maximum value is less than the threshold. When the maximum value is less than the threshold, the process proceeds to step S306. On the other hand, when the maximum value is not less than the threshold, the process proceeds to step S311.

At step S306, the timing controller 28 orders the image sensor 24 to capture an optical image during the exposure time of 1/120x second for generating one frame of a blocked image signal. After generating the blocked image signal, the process proceeds to step S307.

At step S307, the image processing block 301 stores the blocked image data, which was generated in step S306 and digitized, in the SDRAM 27. After storing the blocked image data, the process proceeds to step S308.

At step S308, the image processing block 301 determines whether or not eight frames of blocked image data are stored in the SDRAM 27. When the eight frames of blocked image data have been stored, the process proceeds to step S309. On the other hand, when the eight frames of blocked image data have not been stored, the process proceeds to step S311.

At step S309, the image processing block 301 averages the values of eight artificial black pixel data that correspond to the same pixel, and generates the noise data for each pixel. In addition, the image processing block 301 stores the generated noise data in the SDRAM 27. After storing the noise data, the process proceeds to step S310.

At step S310, the image processing block 301 sets to one the gain used for the general image processing circuit 331 to amplify the image data. After setting the gain, the process proceeds to step S311.

At step S311, the image processing block 301 carries out predetermined image processing, such as color interpolation processing and gamma correction processing, on the image data. After carrying out predetermined image processing, the process proceeds to step S312.

At step S312, the image processing block 301 determines whether or not a command to terminate the display of the moving image has been input to the input block 43. When the command for termination has not been input, the process returns to step S300. At that point, steps S300-S312 are repeated until the command for termination is input. When the command for termination is input, the process of generating the noise data and removing the FPN is terminated.

In the above third embodiment, fixed-pattern noise can be accurately removed with a brief structure of a system because the noise data are generated by reducing the exposure time when there is not a large amount of incident light.

In addition, in the third embodiment, the electronic endoscope has two noise data generating modes (i.e., the first and second noise data generating modes). A user can select either according to the condition.

If there is a large amount of incident light, even if only partially distributed, the noise data cannot be generated for a long time in the first noise data generating mode. However, by selecting the second noise data generating mode, the noise data can be generated early even if there is a large amount of incident light.

On the other hand, in the second noise data generating mode, the power consumption increases because the exposure time for generating the optical image signal and the blocked image signal before generating the noise data is longer than that in the first noise data generating mode. Therefore, if there is not a large amount of incident light, power consumption can be reduced while generating the noise data early by selecting the first noise data generating mode.

The capture of an optical image with the exposure time of 1/60x second is carried out only once when the maximum value of optical image data is less than the threshold, in the first and second embodiments above. The capture of an optical image with the exposure time of 1/120x second is also carried out only once when the maximum value of optical image data is less than the threshold, in the third embodiment above. However, the capture of an optical image with the exposure time of 1/60x or 1/120x second is carried out several times during the predetermined period.

The exposure time for generating the blocked image signal is predetermined to be the photographing exposure time, which is an exposure time for generating the optical image signal, divided by the threshold, in the first to third embodiments above. However, the same effect can be achieved if the exposure time for generating the blocked image signal is shorter than that for generating the optical image signal.

The noise data are generated by averaging a plurality of artificial black pixel data, in the first to third embodiments above. However, the noise data may be generated according to another method using the artificial black pixel data.

The noise data are generated separately for every pixel, in the first to third embodiments above. However, the noise data may not be generated for every individual pixel, but for every row and/or column that the pixels are arranged along.

In general, the FPN component proper to each pixel tends to vary according to the row and column where a pixel is located. And in general, the FPN components of pixels arranged on the same row or column are nearly equal. Accordingly, even if the noise data are generated for every row and/or column, the FPN component can be accurately removed.

The maximum value of the luminance component in pixel data that constitutes one frame of optical image data is compared with the threshold, in the first to third embodiments above. However, the average value of all the pixel data or the average value of partial pixel data may be compared with the threshold. Furthermore, each pixel data may be compared individually with the threshold, and only the artificial black pixel data of the pixel whose pixel data is less than the threshold may be stored in the SDRAM 27.

The maximum luminance component value from among the pixel data that constitutes one frame of optical image data is compared with the threshold, in the first to third embodiments above. However, a plurality of frames of optical pixel data can be averaged for each pixel, and the maximum value or the average value of the averaged pixel data may be compared with the threshold.

The fixed-pattern noise reduction system is applied for the electronic endoscope unit, in the first to third embodiments above. However, the fixed-pattern noise reduction system can be applied for another imaging apparatus, such as a digital still camera or a digital video camera.

The image sensor 24 is a CMOS image sensor, in the first to third embodiments above. However, the image sensor 24 can be another type of image sensor that includes a plurality of pixels, each with an individual amplifier, and where fixed-pattern noise appears that is unique to respective pixels.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2008-265442 (filed on Oct. 14, 2008), which is expressly incorporated herein, by reference, in its entirety.

1. A fixed-pattern noise reduction system comprising:
a receiver that receives optical pixel signals and artificial black pixel signals, pixels generating the optical pixel signals according to the amounts of light received for the duration of a photographing exposure time, the pixels being arranged on an image sensor, the pixels generating the artificial black pixel signals according to the amounts of light received for the duration of a instantaneous exposure time shorter than the photographing exposure time;
a determination circuit that determines whether or not the signal intensity of the optical pixel signal is less than a threshold;
an image sensor driver that orders the image sensor to repeat a first capture until the determination circuit determines that the signal intensity of the optical pixel signal is less than the threshold, and orders the image sensor to carry out a second capture at least one time and to repeat the first capture after the determination circuit determines that the signal intensity of the optical pixel signal is less than the threshold, the pixels of the image sensor generating optical pixel signals for one frame of an image signal for the duration of the photographing exposure time in the first capture, the pixels of the image sensor generating artificial black pixel signals for one frame of an image signal for the duration of the instantaneous exposure time in the second capture;
a subtracter that subtracts noise signals from the optical pixel signals, the noise signals being generated on the basis of the artificial black pixel signal; and
an output circuit that outputs the optical pixel signals before carrying out the second capture, and outputs the optical pixel signals that the subtracter subtracts the noise signals from after carrying out the second capture.

2. A fixed-pattern noise reduction system, according to claim 1, further comprising a controller that controls the determination circuit and the image sensor driver to perform the first capture, the determination whether the signal intensity of the optical pixel signal is less than the threshold, and the second capture until the number, which is predetermined to be more than or equal to two, of frames of the artificial black pixel signals are generated.

3. A fixed-pattern noise reduction system, according to claim 1, wherein the image sensor driver orders the image sensor to perform the second capture a plurality of times during a predetermined period after the determination circuit determines that the signal intensity of the optical pixel signal is less than the threshold.

4. A fixed-pattern noise reduction system, according to claim 2, wherein the subtracter generates the noise signals by averaging a plurality of the artificial black pixel signals generated from the second captures at different times.

5. A fixed-pattern noise reduction system, according to claim 2, wherein,
the subtracter generates the noise signal by averaging a plurality of the received artificial black pixel signals and subtracts the noise signal from the latest optical pixel signal received by the receiver whenever the receiver receives the artificial black pixel signals generated in the second capture after the first time, and
the output circuit outputs the optical pixel signals that the subtracter subtracts the noise signal from while the second capture is being carried out.

6. A fixed-pattern noise reduction system, according to claim 1, wherein the output circuit outputs the latest optical pixel signals received by the receiver while the second capture is being carried out.

7. A fixed-pattern noise reduction system, according to claim 1, wherein the instantaneous exposure time is the photographing exposure time divided by the threshold.

8. A fixed pattern noise reduction system, according to claim 1, wherein,
the image sensor driver orders the image sensor to repeat the first capture with first photographing exposure time until the determination circuit determines that the signal intensity of the optical pixel signal is less than the threshold, and orders the image sensor to repeat the first capture with second photographing exposure time after carrying out the second capture, the second photographing exposure time being m times as long as the first photographing exposure time, m being more than one, and
the output circuit multiplies by m the optical pixel signals generated in the first capture with the first photographing exposure time, the output circuit then outputs the multiplied optical pixel signals before the second capture is carried out.

9. An imaging system comprising:
an image sensor on which pixels are arranged, the pixels generating the optical pixel signals according to the amounts of light received for the duration of a photographing exposure time, the pixels generating the artificial black pixel signals according to the amounts of light received for the duration of a instantaneous exposure time shorter than the photographing exposure time;
a determination circuit that determines whether or not a signal intensity of the optical pixel signal is less than a threshold;
an image sensor driver that orders the image sensor to repeat a first capture until the determination circuit determines that the signal intensity of the optical pixel signal is less than the threshold, and orders the image sensor to carry out a second capture at least one time and to repeat the first capture after the determination circuit determines that the signal intensity of the optical pixel signal is less than the threshold, the pixels of the image sensor generating optical pixel signals for one frame of an image signal for the duration of the photographing exposure time in the first capture, the pixels of the image sensor generating artificial black pixel signals for one frame of an image signal for the duration of the instantaneous exposure time in the second capture;
a subtracter that subtracts noise signals from the optical pixel signals, the noise signals being generated on the basis of the artificial black pixel signal; and
an output circuit that outputs the optical pixel signals before carrying out the second capture, and outputs the optical pixel signals that the subtracter subtracts the noise signal from after carrying out the second capture.

10. An electronic endoscope unit comprising:
an image sensor on which pixels are arranged, the pixels generating the optical pixel signals according to the amounts of light received for the duration of a photographing exposure time, the pixels generating the artificial black pixel signals according to the amounts of light received for the duration of a instantaneous exposure time shorter than the photographing exposure time;
a determination circuit that determines whether or not the signal intensity of the optical pixel signal is less than a threshold;
an image sensor driver that orders the image sensor to repeat a first capture until the determination circuit determines that the signal intensity of the optical pixel signal is less than the threshold, and orders the image sensor to carry out a second capture at least one time and to repeat the first capture after the determination circuit determines that the signal intensity of the optical pixel signal is less than the threshold, the pixels of the image sensor generating optical pixel signals for one frame of an image signal for the duration of the photographing exposure time in the first capture, the pixels of the image sensor generating artificial black pixel signals for one frame of an image signal for the duration of the instantaneous exposure time in the second capture;
a subtracter that subtracts noise signals from the optical pixel signals, the noise signals being generated on the basis of the artificial black pixel signal; and
an output circuit that outputs the optical pixel signals before carrying out the second capture, and outputs the optical pixel signals that the subtracter subtracts the noise signal from after carrying out the second capture.
